(19) United States
(12) Patent Application Publication
(10) Pub. No.: US 2002/0176522 A1
(43) Pub. Date: Nov. 28, 2002

(54) Quadrature envelope-sampling of intermediate frequency signal in receiver

(75) Inventor: Yiping Fan, Fremont, CA (US)

Correspondence Address: Corporate Patent Counsel, Philips Electronics North America Corporation, 580 White Plains Road, Tarrytown, NY, 10591, US

(73) Assignee: KONINKLIJKE PHILLIPS ELECTRONICS N.V.

(21) Appl. No.: 09/865,236

(22) Filed: May 25, 2001

(51) Int. Cl. H04L 27/06

(52) U.S. Cl. 375/340

(57) ABSTRACT

An apparatus and method for the two-dimensional direct intermediate frequency sampling of a received signal. A receiver is equipped with a circuit for converting a received radio frequency signal to an intermediate frequency signal. The converted intermediate frequency signal is sampled by a pair of lowpass analog-to-digital converters. The sampling scheme involves quadrature envelope sampling of the intermediate frequency signal. The sampling scheme further involves sampling the Q-channel signal at a quarter of the intermediate frequency carrier period after the I-channel signal is sampled.

### BACKGROUND OF THE INVENTION

1. Field of the Invention

The present invention relates to sampling of intermediate frequency signals in receivers, and, more particularly, to quadrature envelope sampling of intermediate frequency signals in receivers.

2. Description of the Related Art

The sampling of analog signals by receivers in wireless devices, such as code division multiple access (CDMA) or time division multiple access (TDMA) devices, is performed in several ways. In receivers, a radio frequency (RF) signal is converted into an intermediate frequency (IF) signal. One IF stage is typically used. After proper amplification and filtering at radio frequency (RF) and IF, the received signal is converted by IF mixers into in-phase and quadrature (I/Q) baseband signals. The I/Q signals are filtered by a pair of lowpass channel filters. The I/Q lowpass filter outputs are sampled simultaneously by a pair of lowpass analog-to-digital converters (ADC). The digitized data produced by the converters are processed by digital signal hardware to recover the desired information, such as voice, image, and other data. Due to the circuit mismatch from the I/Q IF mixers and the I/Q lowpass filters, the gain and phase frequency response between the I channel and the Q channel are often not the same. This is called I/Q imbalance. In addition, the DC offset problem is very common with this approach.

Bandpass sampling of an IF signal is another sampling scheme. In this scheme, the received signal is directly sampled at the IF stage by a band pass sampling ADC. The sampling can take place with either oversampling or subsampling. The scheme eliminates two IF mixers and analog lowpass filters as compared to the conventional I/Q lowpass sampling scheme previously described. Furthermore, the bandpass sampling scheme eliminates the I/Q imbalance and the DC offset. However, the cost and complexity of designing, fabricating, and implementing a bandpass ADC and a bandpass digital filter as well as the associated power consumption may limit the usefulness of this sampling approach.

What is needed is an apparatus and method for sampling received signals which possess the benefits of the previous designs, and, furthermore, which eliminate the extra cost and complexity associated with such previous designs.

### SUMMARY OF THE INVENTION

The present invention provides an apparatus and method for the direct intermediate frequency (IF) sampling of a received signal which is modulated by a two-dimensional signal constellation, such as quadrature phase shift keying (QPSK) and quadrature amplitude modulation (QAM). The IF signal is sampled by a pair of lowpass analog-to-digital converters thereby achieving significant savings in power consumption and fabrication cost as compared to the more complex and expensive bandpass analog-to-digital converters and digital bandpass filters while maintaining comparable performance with previous designs.

The present invention, in one form thereof, includes a receiver which overcomes the shortcomings of the prior art. The receiver includes a radio frequency (RF) mixer, an IF filter, and an amplifier. Directly connected to the amplifier is a first and a second ADC which are operable to directly sample the IF signal using a quadrature envelope sampling scheme. Furthermore, a digital signal processor (DSP) is connected to the first and second lowpass analog-to-digital converters and is operable to process the sampled data to recover the desired information.

Furthermore, the present invention includes a method for direct IF sampling of a signal which is modulated by a two-dimensional signal constellation in a receiver. The method includes the steps of receiving a signal and converting the signal to an intermediate frequency using an RF mixer. The method further includes filtering and amplifying the resultant IF signal. The amplified IF signal is directly sampled by a pair of lowpass analog-to-digital converters using a quadrature envelope sampling scheme. A DSP is then used to process the sampled information extracted by the lowpass analog-to-digital converters to recover the desired information.

An advantage of the present invention is the reduced power consumption as compared to previous sampling schemes while maintaining good results.

Another advantage of the present invention is the reduced complexity as compared to previous sampling schemes while maintaining good results.

Yet another advantage of the present invention is the shifting of the digital signal processing toward the antenna.

### BRIEF DESCRIPTION OF THE DRAWINGS

The above-mentioned and other features and advantages of this invention, and the manner of attaining them, will become more apparent and the invention itself will be better understood by reference to the following description of an embodiment of the invention taken in conjunction with the accompanying drawings, wherein:

FIG. 1 is a prior art super heterodyne receiver architecture implementing a lowpass sampling scheme.

FIG. 2 is a prior art super heterodyne receiver architecture implementing a bandpass sampling scheme.

FIG. 3 is a super heterodyne receiver architecture implementing a quadrature envelope sampling scheme according to the present invention.

FIG. 4 is a representation of the quadrature envelope sampling scheme according to the present invention.

FIG. 5 is a plot of the I-channel baseband signal with the quadrature envelope sampling.

FIG. 6 is a plot of the Q-channel baseband signal with the quadrature envelope sampling.

FIG. 7 is a plot of the Q-channel signal distortion with the quadrature envelope sampling.

FIG. 8 is a plot of the power spectrum of the signal and the distortion produced by the quadrature envelope sampling scheme.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

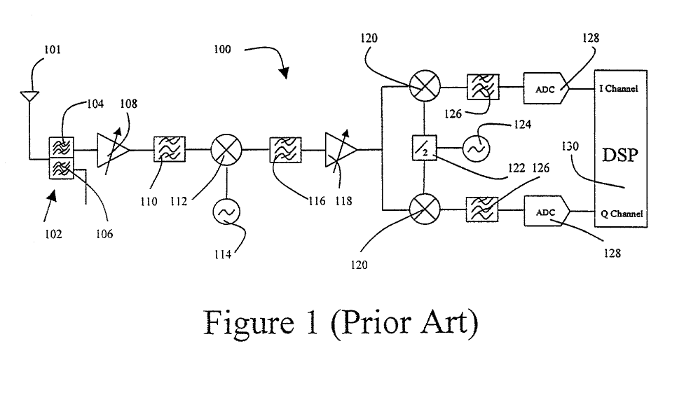

Referring now to the drawings and particularly to FIG. 1, a prior art super heterodyne receiver architecture with lowpass sampling is shown. This super heterodyne receiver 100 utilizes lowpass sampling. Antenna 101 receives an incoming transmitted signal. Antenna 101 is connected to duplex 102. Duplex 102 includes two bandpass filters 104 and 106. Receive filter 104 is operable to pass the frequency of the received signal. Transmit filter 106 is operable to pass the frequency of a transmitted signal. The radio frequency output from receive filter 104 is received by low noise amplifier 108. The amplified output is received by surface acoustic wave filter 110. The filtered signal is then communicated to radio frequency mixer 112. Radio frequency mixer 112 uses radio frequency mixer input 114 to convert the input signal to an intermediate frequency signal. The IF output from mixer 112 is input into surface acoustic wave filter 116. The filtered signal is then input into variable gain amplifier 118. Connected to amplifier 118 are a pair of IF mixers 120. IF mixers 120 down-convert the received signal into in-phase and quadrature (I/Q) baseband signals. The I/Q signals are then filtered by a pair of lowpass channel filters 126. The analog outputs of lowpass filters 126 are sampled by a pair of lowpass analog-to-digital converters 128. The digitized output of converters 128 is input into digital signal processor 130 for further processing to recover the desired information. Lowpass analog-to-digital converters 128 may be converters using Sigma Delta modulation technique.

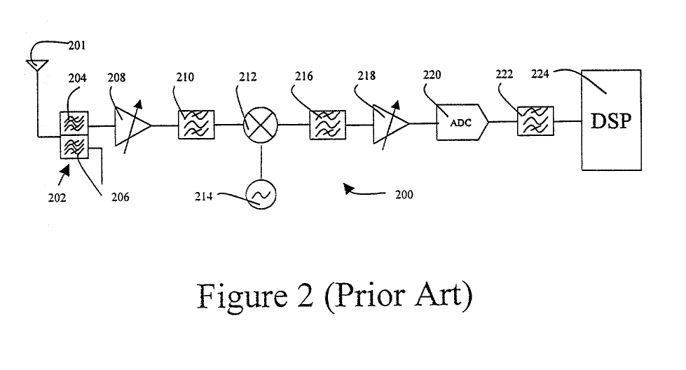

FIG. 2 is a super heterodyne receiver architecture with bandpass sampling shown generally at 200. Antenna 201 receives an incoming transmitted signal. Antenna 201 is connected to duplex 202. Duplex 202 includes two filters 204 and 206. Receive filter 204 is operable to pass the frequency of the received signal. Transmit filter 206 is operable to pass the frequency of a transmitted signal. The radio frequency output from receive filter 204 is received by low noise amplifier 208. The amplified output is received by surface acoustic wave filter 210. The filtered signal is then communicated to radio frequency mixer 212. Radio frequency mixer 212 uses radio frequency mixer input 214 to convert the input signal to an intermediate frequency signal. The IF output from mixer 212 is input into surface acoustic wave filter 216. The filtered signal is then input into variable gain amplifier 218. The IF amplified output from amplifier 218 is input into bandpass analog-to-digital converter 220 which either oversamples or sub-samples the signal. The output of converter 220 is filtered by digital bandpass filter 222 and then transmitted for further processing by digital signal processor 224.

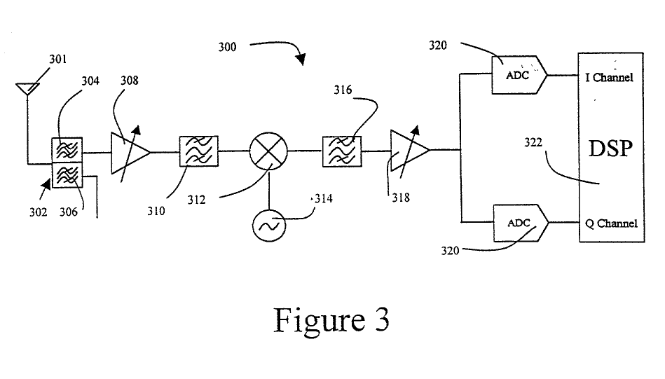

FIG. 3 is a preferred embodiment of a receiver architecture according to the present invention. Receiver 300 uses quadrature envelope sampling. Antenna 301 receives an incoming transmitted signal. Antenna 301 is connected to duplex 302. Duplex 302 includes two filters 304 and 306. Receive filter 304 is operable to pass the frequency of the received signal. Transmit filter 306 is operable to pass the frequency of a transmitted signal. The radio frequency output from receive filter 304 is received by low noise amplifier 308. The amplified output is received by surface acoustic wave filter 310. The filtered signal is then communicated to radio frequency mixer 312. Radio frequency mixer 312 uses radio frequency mixer input 314 to convert the input signal to an intermediate frequency signal. The IF output from mixer 312 is input into surface acoustic wavefilter 316. The filtered signal is then input into variable gain amplifier 318. The IF signal is then directly sampled by a pair of lowpass analog-to-digital converters 320. Direct sampling involves no intervening components between the amplifier and the analog-to-digital converters. Instead of including mixers and filters before the sampling of the IF signal as is present in the prior art, direct sampling permits the sampling of the IF signal without any mixers, analog channel filters, or similar intervening components. The elimination of intervening components reduces cost and complexity by introducing fewer parts into the design and fabrication of the receiver. The output of converters 320 is input into digital signal processor 322 for further processing. The channel filtering with this architecture is performed by the DSP and the I/Q imbalance is minimized. By directly sampling with lowpass analog-to-digital converters 320, a significant saving can be achieved in both power consumption and fabrication cost. Such a configuration discloses a direct IF quadrature envelope sampling scheme for an I/Q signal pair by using a pair of lowpass analog-to-digital converters 320. A fast sample-and-hold circuit must be present at the input of lowpass analog-to-digital converter 320 in order for the quadrature envelope sampling approach to function properly.

In an alternative embodiment, lowpass analog-to-digital converter 320 is a Sigma Delta analog-to-digital converter. In another alternative embodiment, lowpass analog-to-digital converter 320 is a flash-type ADC. If lowpass analog-to-digital converter 320 were a flash-type converter, only one converter would be necessary instead of a pair of converters, thereby further reducing cost and complexity. This is because in the quadrature envelope sampling, the I/Q channels are not sampled simultaneously as in the prior art. Therefore, by time multiplexing, both I and Q channels get sampled by one ADC.

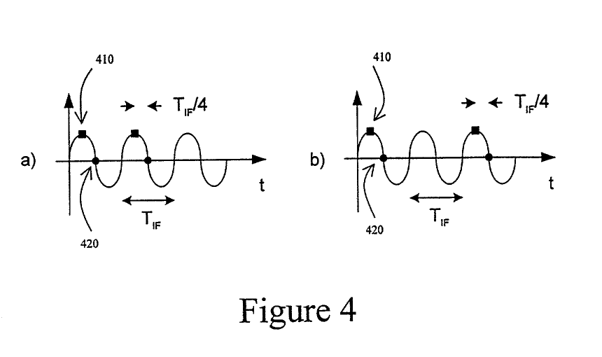

FIG. 4 is a graphical representation of the inventive quadrature envelope sampling scheme according to the present invention. In contrast with conventional prior art I/Q sampling schemes, the I/Q samples from the quadrature envelope sampling scheme are not taken at the same sampling time. In the quadrature envelope sampling scheme, the directly sampled IF signal is sampled in a scheme in which the Q-channel ADC takes a sample a quarter of the IF carrier period before or after the I-channel ADC takes a sample. For demonstration purpose, the Q channel sample is taken a quarter of the IF carrier period later. An I-channel sampling point is shown generally at 410. A Q-channel sampling point is shown generally at 420, ninety degrees after I-channel sampling point 410. The IF carrier period is denoted by T_{IF} and the separation of point 410 and point 420 is shown with arrows indicated by T_{IF}/4. The distance between these arrows represent a quarter of the IF carrier period. The sampling frequency is the same as the intermediate frequency or sub-harmonic frequencies of the intermediate frequency. Essentially, the sampling frequency is equal to the intermediate frequency divided by the order of the sub-harmonics (an integer). In FIG. 4a, the order of the sub-harmonic is one (1), which yields a sampling frequency equal to the intermediate frequency. In FIG. 4b, the order of the sub-harmonic is two (2), which yields a sampling frequency equal to one-half (½) of the intermediate frequency. Since the typical intermediate frequency is much greater than the information bandwidth, the sampling delay (equal to a quarter of the IF carrier period) in the Q-channel (or in the I channel) will not have any practical negative impact as will be shown below.

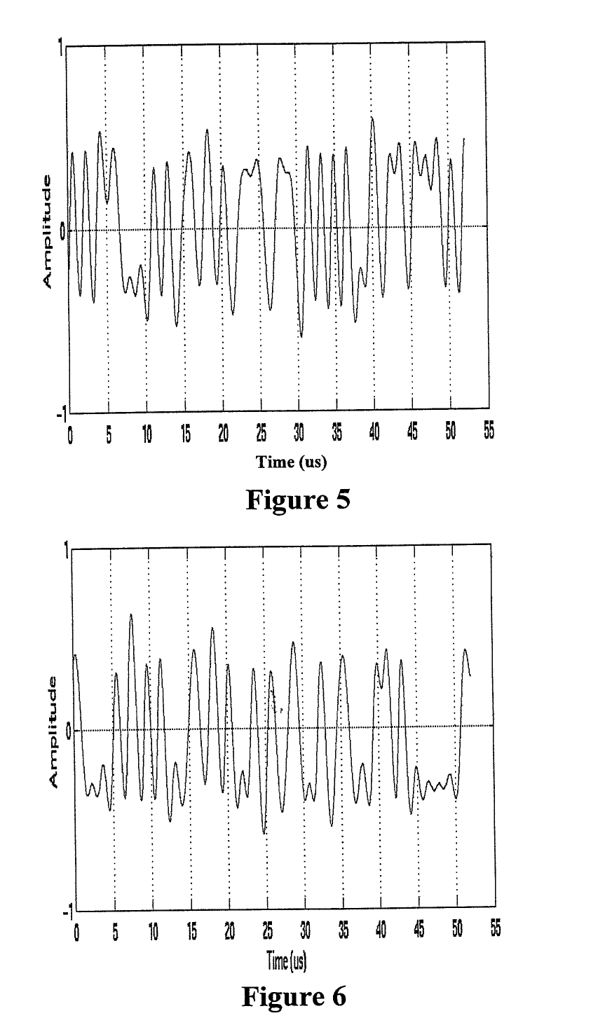

FIG. 5 provides a graphical plot of the directly sampled I-channel baseband signal with the quadrature envelope sampling scheme from FIG. 4. FIG. 5 includes a plot of two curves which, however, are indistinguishable as they are identical. One curve represents the typical I-channel baseband sampling. The second represents the I-channel with quadrature envelope sampling from the IF signal. As expected, the two I-channel curves are identical.

FIG. 6 provides a graphical plot of the directly sampled Q-channel baseband signal with the quadrature envelope sampling scheme from FIG. 4. FIG. 6 includes a plot of two curves. One curve represents the typical Q-channel baseband sampling. The second represents the Q-channel with quadrature envelope sampling from the IF signal. The difference between the two curves is very small and, therefore, the curves appear to overlap one another.

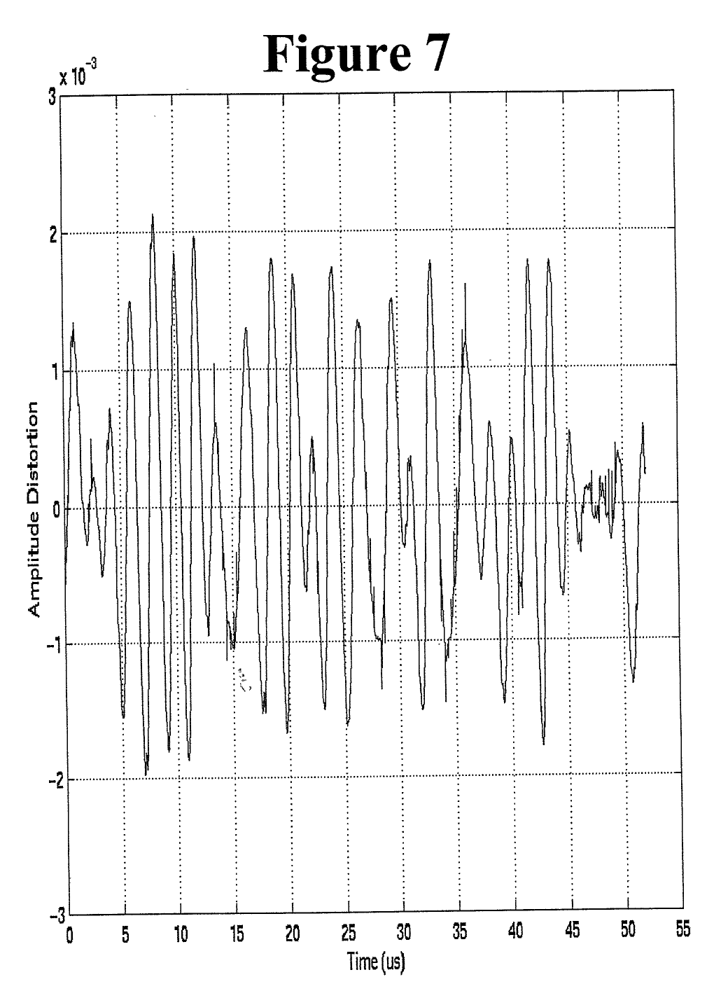

FIG. 7 provides a graphical plot of the distortion calculated by Equation (6) for the Q-channel over the same period as used in FIG. 6. FIG. 7 illustrates the distortion which is the difference between the two curves in FIG. 6. The amount of distortion is very small because the intermediate frequency is much higher than the information bandwidth. A theoretical mathematical analysis of the quadrature envelope sampling scheme is given below.

The received signal, denoted as S(t) with its amplitude and phase as m(t) and □(t) and an arbitrary constant initial phase □, is represented in Equation (1).

S(t)=m(t)·cos[ω_{IF}t+φ(t)+θ]=m(t)·cos[φ(t)+θ]·cos(ω_{IF}t)−m(t)·sin[φ(t)+θ]·sin(ω_{IF}t) Equation (1)

When the sampling point for the I-channel on this received waveform is aligned to the positive

peak of cos(ω_{IF}t) (this assumption can be made because is arbitrary), i.e., cos(ω_{IF}t)=1 and

sin(ω_{IF}t)=0, the sampled I-channel data at the i-th instance (t=tₗ) is given in Equation (2).

I(tₗ)=m(tₗ)·cos[φ(tₗ)+θ] Equation (2)

The sampled Q channel at the i-th instance is (t=tₗ+δ, δ=T_{IF}/4, T_{IF} is the IF carrier period) given by Equation (3).

Q(tₗ)=−m(tₗ+δ)·sin[φ(tₗ+δ)+θ] Equation (3)

Due to phase derotation processing in DSP which uses a reference phase information such as in CDMA cellular communication system, the arbitrary phase is removed. Therefore, the effective sampled I/Q data are given by Equations (4) and (5).

I(tₗ)=m(tₗ)·cos[φ(tₗ)] Equation (4)

Q(tₗ)=−m(tₗ+δ)·sin[φ(tₗ+δ)] Equation (5)

The Q-channel sampled data with the quadrature envelope sampling scheme is distorted and the amount of distortion is given by Equation (6) and is shown in FIG. 7 over the same period as the signals shown in FIGS. 5 and 6.

Δ(tₗ)=m(tₗ)·sin[φ(tₗ)]−m(tₗ+δ)·sin[φ(tₗ+δ)] Equation (6)

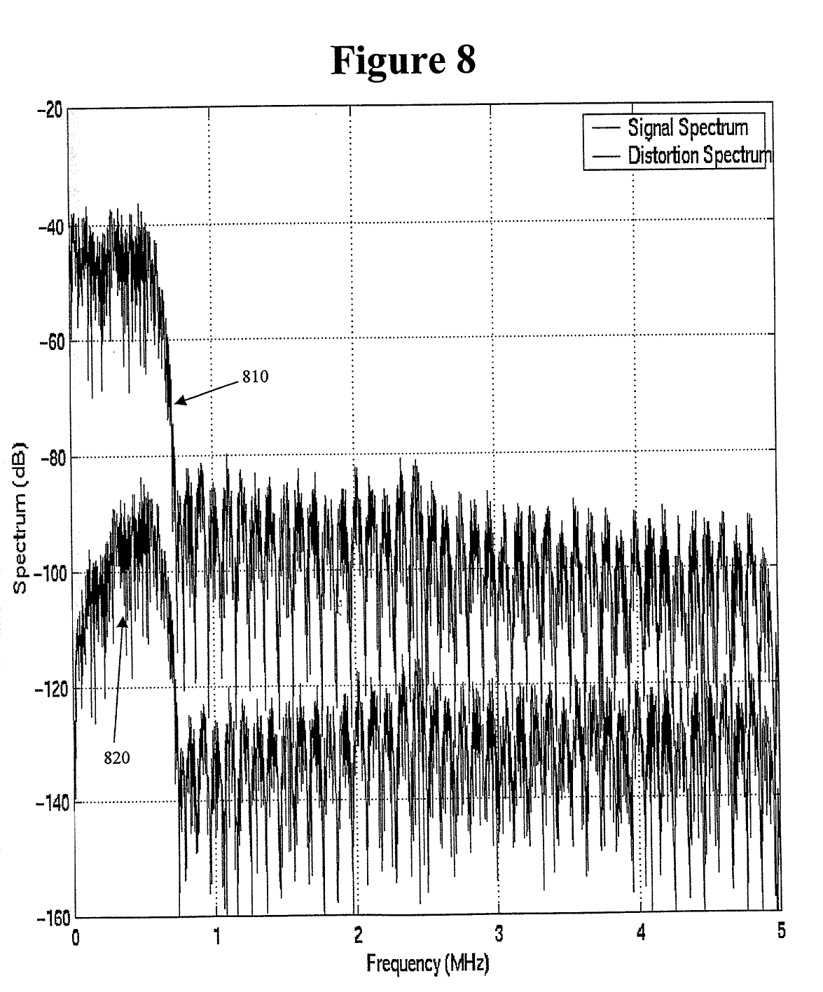

FIG. 8 is a graphical plot of power spectrum 810 of the signal and distortion spectrum 820 as calculated by Equation (6). The ratio of the desired signal energy over the distortion energy (SDR) averaged over M sampling points is calculated using Equation (7). A calculation over a 1280-chip period for the CDMA communication system gives an SDR of approximately 53 dB. The SDR value can be seen in FIG. 8 by observing the difference between power spectrum 810 and distortion spectrum 820.

$$SDR = {\sum }_{i = 1}^{M} {[ Δ ( {t}_{i} ) / m ( {t}_{i} ) ]}^{2} / M \qquad Equation ( 7 )$$

The very high value of the SDR theoretically predicts that the quadrature envelope sampling scheme will not have any negative effects.

As shown in FIG. 8, the spectrum analysis reveals that the spectrum of the distortion signal is also band limited and has the same bandwidth as the signal in FIG. 7. In the frequency domain, the quadrature envelope sampling scheme uses the aliasing property of digital sampling. Therefore, the noise in the image bands will fall back into the signal band. Due to the filtering protection of the IF surface acoustic wavefilter, the noise from the image band is greatly reduced. Therefore, the aliasing noise effect should not be a concern. When the sampling frequency is the third subharmonic frequency of the intermediate frequency, e.g., IF=183.6 MHz, the image band is already outside of the US cellular receive band.

While this invention has been described as having a preferred design, the present invention can be farther modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A receiver comprising:
a radio frequency mixer;
an intermediate frequency filter;
an amplifier;
a first lowpass analog-to-digital converter directly connected to said amplifier;
a second lowpass analog-to-digital converter directly connected to said amplifier; and
a digital signal processor connected to said first and second lowpass analog-to-digital converters.

2. The receiver according to claim 1 wherein said receiver forms a part of a communications device.

3. The receiver according to claim 2 wherein said communications device comprises a cellular phone.

4. The receiver according to claim 2 wherein said communications device comprises a wireless device.

5. The receiver according to claim 2 wherein said communications device comprises a code division multiple access (CDMA) device.

6. The receiver according to claim 2 wherein said communications device comprises a time division multiple access (TDMA) device.

7. The receiver according to claim 1 further comprising a radio frequency filter.

8. The receiver according to claim 7 wherein said radio frequency filter comprises a surface acoustic wave filter.

9. The receiver according to claim 1 wherein said intermediate frequency filter comprises a surface acoustic wave filter.

10. The receiver according to claim 1 wherein said amplifier comprises a variable gain amplifier.

11. The receiver according to claim 1 wherein said first and second lowpass analog-to-digital converters comprise Sigma Delta analog-to-digital converters.

12. The receiver according to claim 1 wherein said first lowpass analog-to-digital converter comprises a flash-type analog-to-digital converter.

13. A method for direct sampling of an intermediate frequency signal in a receiver comprising:
receiving a signal;
converting said signal to an intermediate frequency signal;
filtering said intermediate frequency signal;
amplifying said filtered intermediate frequency signal;
directly sampling said amplified intermediate frequency signal; and
processing said directly sampled signal with a digital signal processor.

14. The method according to claim 13 wherein said direct sampling comprises:
sampling a first channel at a predetermined time; and
sampling a second channel a quarter of the intermediate frequency carrier period after said sampling of said first channel.

15. The method according to claim 13 wherein said direct sampling is accomplished with a pair of lowpass analog-to-digital converters.

16. The method according to claim 15 wherein said lowpass analog-to-digital converters comprise Sigma Delta analog-to-digital converters.

17. The method according to claim 13 wherein said direct sampling is accomplished with a single flash-type lowpass analog-to-digital converter.
